(19) United States
(12) Patent Application Publication
(10) Pub. No.: US 2025/0146615 A1
(43) Pub. Date: May 8, 2025

(54) Tool Support Device

(71) Applicants: Gary Kasch, Hancock, WI (US); Susan Kasch, Hancock, WI (US)

(72) Inventors: Gary Kasch, Hancock, WI (US); Susan Kasch, Hancock, WI (US)

(21) Appl. No.: 18/940,295

(22) Filed: Nov. 7, 2024

Related U.S. Application Data
(60) Provisional application No. 63/596,780, filed on Nov. 7, 2023.

(51) Int. Cl. F16M 11/10; F16M 11/28

(52) U.S. Cl. CPC F16M 11/10; F16M 11/28; F16M 2200/021; F16M 2200/025; F16M 2200/08

(57) ABSTRACT

A tool support device is provided. The device is comprised of a fastener that allows the device to be attached to any tool commonly used around the home. The device is also comprised of a stand member that may extend from the tool to support the tool such that the tool is propped up along any surface at an easily accessible height.

### CROSS-REFERENCE TO RELATED APPLICATION

The present application claims priority to, and the benefit of, U.S. Provisional Application No. 63/596,780, which was filed on Nov. 7, 2023, and is incorporated herein by reference in its entirety.

### FIELD OF THE INVENTION

The present invention relates generally to the field of tool accessories. More specifically, the present invention relates to a tool support device comprised of a fastener that allows the device to be attached to any tool. The device is also comprised of a stand member that may extend from the tool to support the tool such that the tool is propped up along any surface at an easily accessible height. Accordingly, the present disclosure makes specific reference thereto. Nonetheless, it is to be appreciated that aspects of the present invention are also equally applicable to other like applications, devices, and methods of manufacture.

### BACKGROUND

Utilizing sizable gardening and construction tools, such as rakes, shovels, and other similar implements, often involves the necessity of setting these tools down on the ground while they are intermittently used throughout a project. This common practice is far from ideal, as it obliges users to repeatedly stoop or bend down each time they need to retrieve a tool for use. This repetitive motion can prove especially strenuous and even detrimental for users who suffer from physical impairments, as it demands significant strength, endurance, and flexibility. For such individuals, this requirement to bend frequently can exacerbate existing physical conditions, increase discomfort, and decrease overall productivity by making the task more laborious and time-consuming. This aspect of using large tools not only impacts the efficiency with which physically impaired users can work but also affects their ability to engage in tasks comfortably and safely.

Therefore, there exists a long-felt need in the art for a device that can support a tool. There also exists a long-felt need in the art for a tool support device that can be universally attached to any tool. Further, there exists a long-felt need in the art for a tool support device that can be attached to a tool and wherein usage of the device does not require that a user bend down to pick up the tool from a ground surface during use.

The subject matter disclosed and claimed herein, in one embodiment thereof, comprises a tool support device. The device is comprised of a fastener that allows the device to be attached to any hand tool. The device is also comprised of a stand member that may extend from the tool to support the tool such that the tool is propped above a surface at an easily accessible height.

In this manner, the tool support device of the present invention accomplishes all the foregoing objectives and provides a device that can support a tool during use. Further, the device can universally attach to any tool. During use, the device does not require that a user bend down to pick up the tool from a ground surface during use.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a tool support device primarily comprised of a fastener and a stand member. The device is designed to be secured to a large hand tool such that the tool can be propped up on any surface, allowing the handle of the tool to be easily accessible when switching between multiple tools on a project.

The device is comprised of a fastener that allows the device to be easily secured to any tool. In one potential embodiment, the fastener is a hinge that fixedly attaches the device to the tool, allowing the device to freely rotate away from the tool. In another embodiment, the fastener removably attaches the device to the tool. The fastener may be any fastener known in the art.

The device is further comprised of a stand member, preferably made from a plastic or metal material. A first end of the stand member may be fixedly attached to the fastener of the device. A second end of the stand member may support the tool from a ground surface. In one embodiment, the second end may be pointed to insert into softer ground surfaces. In another embodiment, the second end may be flat to provide support on harder ground surfaces. The second end may further be telescoping in differing embodiments to allow the second end to increase in length to accommodate tools of different sizes.

The present invention is also comprised of a method of using the device. First, a device is provided primarily comprised of a fastener and a stand member. Then, the device may be attached to a tool via a fastener. Then, the stand member may be rotated away from the tool via a hinge to an angle desired by the user. Next, the stand member may rest in or on a ground surface such that the tool is held at an angle that is greater than zero degrees above the ground surface.

Accordingly, the tool support device of the present invention is particularly advantageous as it provides a device that can support a tool during use. Further, the device can universally attach to any tool. During use, the device does not require that a user bend down to pick up the tool from a ground surface during use. In this manner, the tool support device provides a useful tool accessory that eliminates drawbacks with existing methods of using said tools.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a tool support device of the present invention while attached to a tool and while deployed while supporting the tool in accordance with the disclosed architecture;

FIG. 2 illustrates a perspective view of one potential embodiment of a tool support device of the present invention while attached to a tool and while undeployed in accordance with the disclosed architecture; and

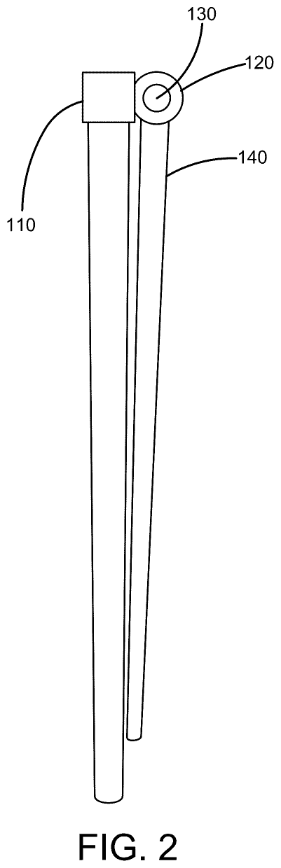

FIG. 3 illustrates a flowchart of a method of using one potential embodiment of a tool support device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that can support a tool. There also exists a long-felt need in the art for a tool support device that can be universally attached to any tool. Further, there exists a long-felt need in the art for a tool support device that can be attached to a tool and wherein usage of the device does not require that a user bend down to pick up the tool from a ground surface during use.

The present invention, in one exemplary embodiment, is comprised of a tool support device. The device is primarily comprised of a fastener and a stand member. The device is designed to be secured to a large hand tool such that the tool can be propped up on any surface, allowing the handle of the tool to be easily accessible when switching between multiple tools on a project.

More specifically, the device is comprised of a fastener. The fastener allows the device to be easily secured to any tool. In one potential embodiment, the device may be permanently secured to the tool via at least one hinge, allowing the device to move closer to and further from the tool. In this embodiment, the hinge may be comprised of a locking mechanism that allows the device to be rotated to a fixed angle away from the tool, providing additional support. In another potential embodiment, the fastener may be removably attached to the tool, allowing the device to be attached only when needed and removed during use, storage, or any other time as deemed necessary by a user. The fastener may be any fastener known in the art.

The device is further comprised of a stand member. The stand member may be made from any material but is preferably made from a plastic or metal material. A first end of the stand member may be fixedly attached to the hinge of the device, allowing the stand member to rotate away from the tool from which the device is attached. The stand member is further comprised of a second end. In differing embodiments, the second end of the stand member may come to a point, allowing the second end to be driven into the ground, or be flat to accommodate hard, flat surfaces. In one potential embodiment, the second end of the stand member may be telescoping, allowing the length of the second end to be variable. In this embodiment, the second end may be further comprised of a locking mechanism that fixes the length of the second end at any length as desired by the user.

The present invention is also comprised of a method of using the device. First, a device is provided primarily comprised of a fastener and a stand member. Then, the device may be attached to a tool via a fastener. Then, the stand member may be rotated away from the tool via a hinge to an angle desired by the user. Next, the stand member may rest in or on a ground surface such that the tool is held at an angle that is greater than zero degrees above the ground surface.

Accordingly, the tool support device of the present invention is particularly advantageous as it provides a device that can support the weight of a tool, allowing the tool to remain in an upright position. More specifically, the support tool device can be easily attached to any tool commonly used for maintenance inside or outside of the home. Furthermore, the support tool device can be moved or removed from the tool to allow for ease of storage or use. In this manner, the tool support device provides a useful tool accessory.

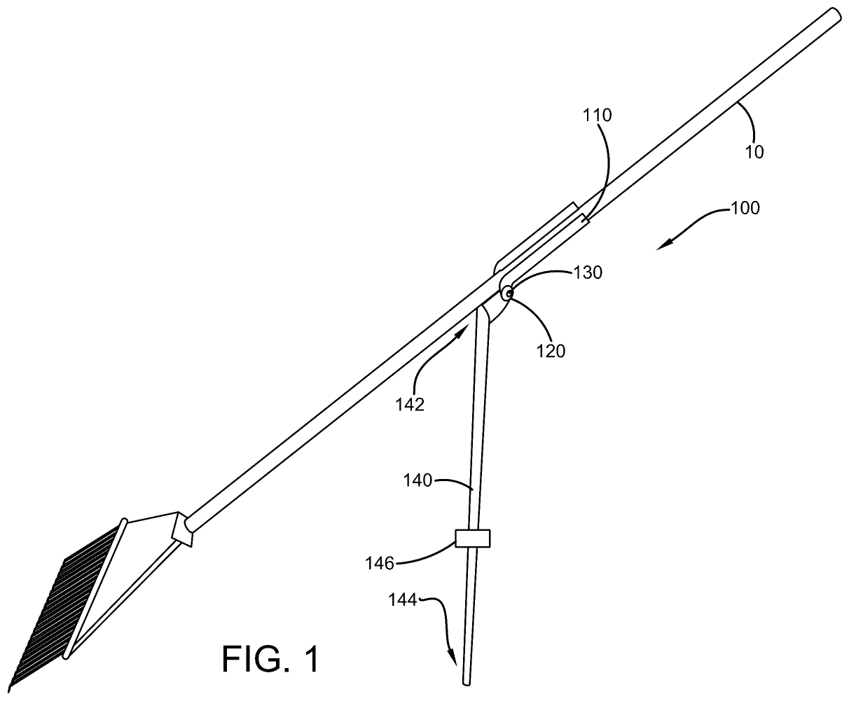

Referring initially to the drawings, FIG. 1 illustrates a perspective view of one potential embodiment of a tool support device 100 of the present invention while attached to a tool 10 and while deployed while supporting the tool 10 in accordance with the disclosed architecture. The device 100 is primarily comprised of at least one fastener 110 and at least one stand member 140. The device 100 is designed to be attached to a large hand tool 10 such that the tool 10 can be propped up on any surface, allowing the handle of the tool 10 to be easily accessible when switching between multiple tools 10 on a project and preventing the user from having to reach down to pick the tool 10 off the ground.

The fastener 110 may be any fastener known in the art that allows the device 100 to be attached to a tool 10 such as, but not limited to, a magnet, a clip, a clamp, a bolt, a screw, a hinge, a hook-and-loop fastener, a groove, an adhesive, etc. The tool 10 may be any tool such as, but not limited to, a rake, a shovel, a bar, a broom, etc., or other similar hand tools of the like. In differing embodiments of the device 100, the fastener 110 may fixedly or removably attach the device 100 to the tool 10. In the embodiment in which the device 100 is removably attached, the device 100 may only be attached to the tool 10 as needed and removed during use, storage, or any other time as preferred by the user.

In one embodiment, the fastener 110 attaches to at least one hinge 120. The hinge 120 may be further comprised of at least one locking mechanism 130. The locking mechanism 130 may set a limit on maximum rotation angle (between 0 and 180 degrees) away from a vertical or a horizontal axis of the tool 10 or provide incremental angles from which the rotation of the device 100 away from the tool 10 may be fixed, providing support for the tool 10 at a desired angle.

The device 100 is further comprised of a stand member 140. The stand member 140 may be made from any material, such as wood, but is preferably made from a plastic or lightweight metal material. The stand member 140 is further comprised of a first end 142 and a second end 144. The first end 142 of the stand member 140 may be fixedly attached to the hinge 120 of the device 100, allowing the stand member 140 to rotate away from the tool 10 from which the device 100 is attached. The second end 144 of the stand member 140 may provide support from the ground surface for the tool 10. In one potential embodiment, the second end 144 may come to a point such that it may be driven into soft ground, such as dirt, sand, or clay. In another potential embodiment, the second end 144 may be flat, providing support on hard surfaces, such as concrete, pavement, or gravel. In one potential embodiment of the device 100, the second end 144 of the stand member 140 may be telescoping, allowing the length of the second end 144 to be variable. In this embodiment, the second end 144 may be comprised of a locking mechanism 146 that temporarily fixes the length of the second end 144 to the preferences of the user. The locking mechanism 146 may be freely used at any point along the length of the second end 144 or only be used at specific locations along the length of the second end 144 in differing embodiments.

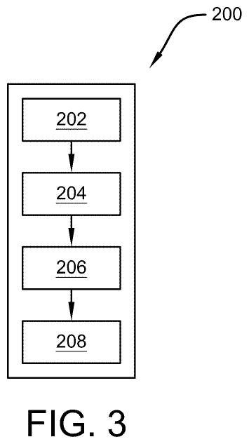

The present invention is also comprised of a method 200 of using the device 100, as seen in FIG. 3. First, a device 100 is provided primarily comprised of at least one fastener 110, a hinge 120, and at least one stand member 140 [Step 202]. Then, the device 100 may be attached to a tool 10 via the fastener 110 [Step 204]. Then, the stand member 140 may be rotated away from the tool via a hinge 120 to an angle (between 1 and 179 degrees) desired by the user [Step 206]. Next, the stand member 140 may rest in or on a ground surface such that the tool 10 is held at an angle that is greater than zero degrees above the ground surface such that the tool 10 can be easily grabbed without the need to fully bend down and pick the tool 10 off of the ground surface (as if the tool 10 was lying flat) [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “tool support device” and “device” are interchangeable and refer to the tool support device 100 of the present invention.

Notwithstanding the foregoing, the tool support device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the tool support device 100 as shown in the FIGS. are for illustrative purposes only, and that many other sizes and shapes of the tool support device 100 are well within the scope of the present disclosure. Although the dimensions of the tool support device 100 are important design parameters for user convenience, the tool support device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A tool support device comprising:
a fastener;
a hinge attached to the fastener; and
a stand member attached to the hinge.

2. The tool support device of claim 1, wherein the stand member is comprised of a pointed end.

3. The tool support device of claim 1, wherein the stand member is comprised of a flat end.

4. The tool support device of claim 1, wherein the fastener is comprised of a magnet, a clip, a clamp, a bolt, a screw, a hinge, a hook and loop fastener, a groove, or an adhesive.

5. The tool support device of claim 1, wherein the stand member is telescopic.

6. The tool support device of claim 5, wherein the stand member is comprised of a locking mechanism.

7. A tool support device comprising:
a fastener;
a hinge attached to the fastener, the hinge comprised of a first locking mechanism; and
a stand member attached to the hinge.

8. The tool support device of claim 7, wherein the stand member is comprised of a pointed end.

9. The tool support device of claim 7, wherein the stand member is comprised of a flat end.

10. The tool support device of claim 7, wherein the fastener is comprised of a magnet, a clip, a clamp, a bolt, a screw, a hinge, a hook and loop fastener, a groove, or an adhesive.

11. The tool support device of claim 7, wherein the stand member is telescopic.

12. The tool support device of claim 11, wherein the stand member is comprised of a second locking mechanism.

13. The tool support device of claim 7, wherein the first locking mechanism locks the position of the hinge.

14. The tool support device of claim 7, wherein the hinge can rotate between 0 and 180 degrees.

15. A method of using a tool support device, the method comprising:
providing a tool support device comprised of a fastener, a hinge, and a stand member;
attaching the fastener to a tool;
rotating the stand member away from the tool via the hinge; and
resting the stand member on or placing the tool stand member into a ground surface.

16. The method of using the tool support device of claim 15, wherein the stand member is comprised of a pointed end.

17. The method of using the tool support device of claim 15, wherein the stand member is comprised of a flat end.

18. The method of using the tool support device of claim 15, wherein the fastener is comprised of a magnet, a clip, a clamp, a bolt, a screw, a hinge, a hook and loop fastener, a groove, or an adhesive.

19. The method of using the tool support device of claim 15, wherein the stand member is telescopic.

20. The method of using the tool support device of claim 19, wherein the stand member is comprised of a second locking mechanism.
